(19) United States
(12) Patent Application Publication
(10) Pub. No.: US 2026/0186943 A1
(43) Pub. Date: Jul. 2, 2026

(54) Identification and Classification of Usage Pattern in Distributed Software Environment

(71) Applicant: Telefonaktiebolaget LM Ericsson (publ), Stockholm (SE)

(72) Inventors: Andrea Petronio, Genova (IT); Paolo Bottaro, Genova (IT); Fabio Acquarone, Genova (IT)

(21) Appl. No.: 19/131,256

(22) PCT Filed: Nov. 21, 2022
(86) PCT No.: PCT/IB2022/061222

§ 371 Date: May 20, 2025

(51) Int. Cl. G06F 11/34

(52) U.S. Cl. CPC G06F 11/3452; G06F 11/3476; G06F 11/3495; G06F 2201/835; G06F 2201/865

(57) ABSTRACT

Embodiments include methods performed by a monitoring function for a computing environment configured to host a plurality of atomic software functions (AFs) usable by applications executing in the computing environment. Such methods include performing pattern analysis on entries of a database to identify one or more candidate recurrent patterns. Each database entry includes an AF identifier uniquely associated with one of the AFs and a time at which the identified AF was invoked in the computing environment. Each candidate recurrent pattern includes a plurality of instances of a same sequence of AF identifiers in a same chronological order. Such methods include validating a first one or more candidate recurrent patterns as applications and/or use cases and assigning respective use case tags to the validated first candidate recurrent patterns. Such methods include updating the database such that each assigned use case tag is stored in association with the database entries that are associated with the corresponding validated candidate recurrent pattern. Other embodiments include monitoring functions (e.g., apparatus) configured to perform such methods.

### TECHNICAL FIELD

The present disclosure relates generally to the field of distributed computing, and more specifically to techniques for identifying and classifying usage patterns (or “use cases”) in software that is based on various services hosted in a distributed (or “cloud”) environment.

### BACKGROUND

In general, “cloud computing” refers to the delivery of remote computing services such as application servers, storage, databases, networking, analytics, and intelligence to users over the Internet. “Cloud” infrastructure” generally refers to the hardware and software components such as servers, storage, networking, etc., that are needed to support the computing requirements of a cloud computing model. Cloud infrastructure also typically includes an abstraction layer that virtualizes the hardware resources and logically presents them to users (e.g., as “virtual machines”) through application program interfaces (APIs). Such virtualized resources are typically hosted by a service provider are delivered to users over the public Internet or a private network. Publicly available cloud infrastructure can be referred to as “infrastructure as a service”. Cloud infrastructure is typically built on top on large scale commodity servers, typically based on the well-known Intel x86 architecture used in personal computing.

Cloud technology has swiftly transformed information and communications technology (ICT) and it is continuing to spread to new areas. A common platform used to provide cloud-based services is Kubernetes, which can coordinate a highly available cluster of connected computers (also referred to as “processing elements” or “hosts”) to work as a single unit. Kubernetes deploys applications packaged in “containers” (e.g., via its “container runtime”) to decouple them from individual computing hosts. Kubernetes abstractions facilitate deploying applications to a cloud-based computing cluster without tying them specifically to individual computing machines. In this manner, containerized applications are more flexible and available than in deployment modes where applications were installed directly onto specific machines. Such containerized applications are referred as “cloud-native” applications.

Conventionally, applications were developed based on “monolithic” architectures, in which all application processes are tightly coupled and run as a single service. As such, if one application process experiences a spike in demand, the entire application architecture must be scaled. Furthermore, adding or improving a monolithic application's features becomes more complex as the application's code base grows. Monolithic architectures increase risk of application unavailability (or down-time) due to the large number of processes and tight dependencies between them.

In contrast, cloud-native applications typically use “microservices” architectures, where the application is built as a collection of independent processes. Each process performs a single, well-defined function and runs as its own service. The services of a cloud-native application communicate via well-defined, lightweight application programming interfaces (APIs). Because they are independently run, each service can be updated, deployed, and scaled to meet demand for specific functions of an application.

Currently, cloud-native applications are often developed based on frameworks that can easily adapt a single cloud computing environment to a wide set of applications, use cases, and/or usage scenarios. For example, such frameworks can be used for pre-defined, off-the-shelf applications as well as custom applications created based on customer-specific needs using software development toolkits. Thus, a software framework should provide an ecosystem in which vendors, integrators, and customers can collaborate to develop and implement a range of cloud-native applications that can grow according to customer needs.

### SUMMARY

One essential capability for such an ecosystem is monitoring usage of the application framework to understand behavior. Ideally, the monitoring should be able to provide patterns of application usage and load-related statistics. This information can facilitate troubleshooting as well identification of deviations from standard usage patterns. Although microservices architectures used in cloud-native applications have many advantages, they also create various problems, issues, and/or difficulties for identifying and classifying application usage patterns.

Accordingly, embodiments of the present disclosure address these and other problems, issues, and/or difficulties by providing automated techniques to identify, classify, and validate usage patterns in distributed software environments based on identifiers associated with “atomic functions” (e.g., services).

Some embodiments include exemplary methods (e.g., procedures) performed by a monitoring function for a computing environment configured to host a plurality of atomic software functions (AFs) that are usable by applications executing in the computing environment.

These exemplary methods can include performing pattern analysis, on entries of a database operably coupled to the monitoring function, to identify one or more candidate recurrent patterns. Each database entry includes the following: an AF identifier uniquely associated with one of the AFs, and a time at which the identified AF was invoked in the computing environment. Each candidate recurrent pattern includes a plurality of instances of a same sequence of AF identifiers in a same chronological order.

These exemplary methods can also include validating a first one or more of the candidate recurrent patterns as one or more of the following: applications, and use cases associated with at least one application. These exemplary methods can also include assigning respective use case tags to the validated first candidate recurrent patterns and updating the database such that each assigned use case tag is stored in association with the database entries that are associated with the corresponding validated candidate recurrent pattern.

In some embodiments, validating the first candidate recurrent patterns is based on a complete match between each first candidate recurrent pattern and a reference AF sequence associated with one of the following: a predefined use case, or a complete higher-level logical activity or operation.

In some embodiments, a plurality of first candidate recurrent patterns are validated and assigned respective first use case tags and validating the first candidate recurrent patterns includes identify a higher-level use case based on the plurality of first candidate recurrent patterns. In such case, these exemplary methods can also include assigning to the plurality of first candidate recurrent patterns a second use case tag corresponding to the higher-level use case.

In some embodiments, these exemplary methods can also include identifying a second one or more of the candidate recurrent patterns as partially valid, based on a partial match between each second candidate recurrent pattern and a reference AF sequence associated with one of the following: a predefined use case, or a complete higher-level logical activity or operation. In some of these embodiments, each partial match is based on one or more of the following differences between a candidate recurrent pattern and a reference AF sequence:
each AF sequence in the candidate recurrent pattern is missing a same one or more entries in the reference AF sequence; and
each AF sequence in the candidate recurrent pattern includes a same one or more entries that are missing from the reference AF sequence.

In some embodiments, these exemplary methods can also include identifying a third one more of the candidate recurrent patterns as one or more of the following: invalid, an error condition, misuse of the computing environment, an artifact of the pattern analysis, and multiple repetitions of a random sequence of AF identifiers. In some of these embodiments, performing pattern analysis includes discarding any of the identified candidate recurrent patterns that appear on a rejected list. In such case, these exemplary methods can also include updating the rejected list to include the third candidate recurrent patterns or identifiers thereof.

In some embodiments, these exemplary methods can also include, for each validated first candidate recurrent pattern, assigning respective tag instance identifiers to respective instances of the sequence of AF identifiers comprising the first candidate recurrent pattern. In such case, the database is further updated such that the respective tag instance identifiers are stored in association with the database entries that are associated with the corresponding validated candidate recurrent pattern.

In some embodiments, these exemplary methods can also include performing one or more of the following using the database updated to include the use case tags: benchmarking, automated testing, tracing, troubleshooting, identification of standard usage patterns and deviations therefrom, and system auditing for resource needs.

In some embodiments, these exemplary methods can also include logging entries in the database for each invocation of one of the AFs in the computing environment. In such case, pattern analysis is performed on the logged database entries. In other embodiments, each database entry can be logged by one of the following: a logging function separate from the monitoring function, an application programming interface (API) of the AF identified in the database entry, an API of the database.

In some embodiments, each database entry also includes one or more of the following associated with the identified AF: an operation description, and operational parameters used for invocation. In some embodiments, each AF identifier and each use case tag is in a human-readable format (e.g., in the database).

In some embodiments, performing pattern analysis on entries of the database to identify one or more candidate recurrent patterns includes filtering or disregarding any differences, among the plurality of instances included in an identified candidate recurrent pattern, in database entries that are chronologically intervening but not part of the sequence of AF identifiers in each instance.

In some embodiments, the computing environment is associated with a communication network that includes at least two of the following domains: radio access network (RAN), core network (CN), IP multimedia system (IMS), and operations support system (OSS). In such embodiments, each of the plurality of AFs is hosted by one of the domains of the communication network.

Other embodiments include monitoring functions (e.g., network nodes, computing apparatus, etc.) that are configured to perform the operations corresponding to any of the exemplary methods described herein. Other embodiments include non-transitory, computer-readable media storing computer-executable instructions that, when executed by processing circuitry, configure such monitoring functions to perform operations corresponding to any of the exemplary methods described herein.

These and other embodiments described herein can be used in a system, product, and/or software development phase for automated testing to identify to identify standard patterns and determine pre-defined use cases according to system, product, and/or software specifications. Identifying pre-defined use cases in this manner can simplify and/or improve efficiency of the subsequent testing phase by facilitating tracing based on easy-to-read use case tags and identification of deviations that can be caused by application errors or exceptions.

Embodiments described herein can also be used during system operation to identify use cases based on actual end user patterns, as well as possible misuses of the system. The use cases identified during system operation may include pre-defined use cases identified during the development phase, as well as other use cases not previously identified. This is beneficial since each system that uses the same AFs may be deployed in different ways by different customers. Embodiments can also distinguish these new/evolved use cases from system misuse and error conditions based on validation.

In this manner, embodiments can improve system supportability by facilitating easier human analysis of logs based on use case tags that are automatically assigned. Additionally, embodiments can improve system serviceability by identifying new uses cases that are driven by system flexibility and customer adaptations.

These and other objects, features, and advantages of the present disclosure will become apparent upon reading the following Detailed Description in view of the Drawings briefly described below.

### BRIEF DESCRIPTION OF THE DRAWINGS

FIG. 1 shows an illustrative example of differences between monolithic and microservices architectures.

FIG. 2 shows an exemplary cloud computing environment in which various atomic software functions (AFs) are executing.

FIG. 3 shows an exemplary communication network in which various AFs are executing.

FIG. 4 shows exemplary trace records generated by various AFs executing in the communication network shown in FIG. 3.

FIG. 5 shows a merge of the AF trace records shown in FIG. 4, arranged in chronological order based on increasing timestamp values.

FIG. 6 shows an exemplary computing system in which some embodiments of the present disclosure can be implemented.

FIG. 7 shows an exemplary communication network in which some embodiments of the present disclosure can be implemented.

FIG. 8 illustrates operation of some embodiments of the present disclosure in the context of the chronologically ordered AF sequence shown in FIG. 5.

FIG. 9 shows an exemplary data structure for storage of use case tags in association with AF sequences, according to some embodiments of the present disclosure.

FIG. 10 illustrates operation of other embodiments of the present disclosure in the context of the chronologically ordered AF sequence shown in FIG. 5.

FIG. 11 (which includes FIGS. 11A-B) shows an exemplary method (e.g., procedure) for a monitoring function for a computing environment, according to various embodiments of the present disclosure.

FIG. 12 shows a communication system according to various embodiments of the present disclosure.

FIG. 13 shows a network node according to various embodiments of the present disclosure.

FIG. 14 shows host computing system according to various embodiments of the present disclosure.

FIG. 15 is a block diagram of an exemplary computing environment in which various embodiments of the present disclosure can be implemented.

### DETAILED DESCRIPTION

Embodiments briefly summarized above will now be described more fully with reference to the accompanying drawings. These descriptions are provided by way of example to explain the subject matter to those skilled in the art and should not be construed as limiting the scope of the subject matter to only the embodiments described herein. More specifically, examples are provided below that illustrate the operation of various embodiments according to the advantages discussed above.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods and/or procedures disclosed herein do not have to be performed in the exact order disclosed, unless a step is explicitly described as following or preceding another step and/or where it is implicit that a step must follow or precede another step. Any feature of any of the embodiments disclosed herein can be applied to any other embodiment, wherever appropriate. Likewise, any advantage of any of the embodiments can apply to any other embodiments, and vice versa. Other objects, features and advantages of the disclosed embodiments will be apparent from the following description.

As briefly mentioned above, software applications were conventionally developed based on “monolithic” architectures, in which all application processes are tightly coupled and run as a single service. In contrast, cloud-native applications typically use “microservices” architectures, where the application is built as a collection of independent processes.

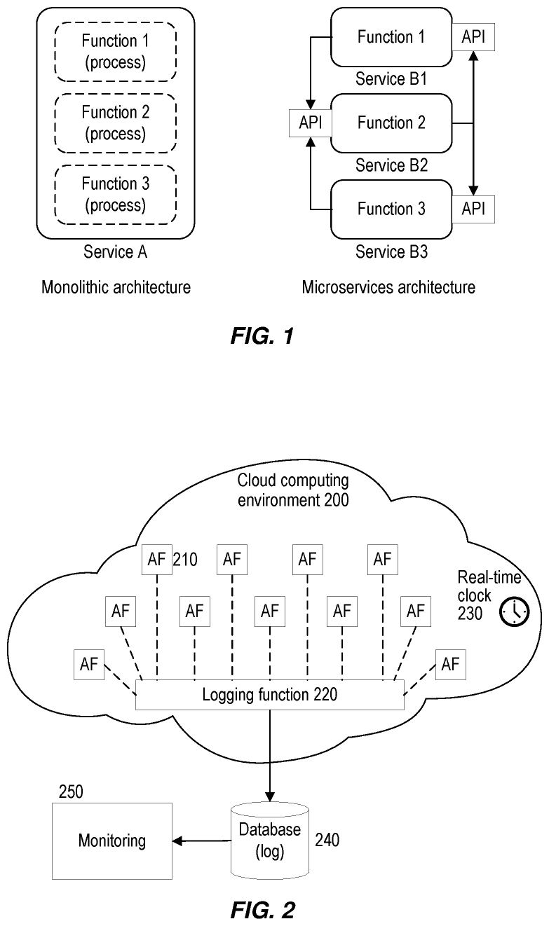

FIG. 1 shows an illustrative example of differences between monolithic and microservices architectures. An application developed based on a monolithic architecture is on the left. This application runs as a single service “A” and includes functions 1-3, each of which runs as an individual process within service A. An application developed based on a microservices architecture is on the right. This application includes the same functions 1-3, which run as respective services B1-B3. These services communicate with each other via well-defined, lightweight APIs. Because they are independently developed and run, each service can be updated, deployed, and scaled to meet demand for specific functions of an application. For example, services do not need to share any of their code or implementation with other services.

Microservices facilitate small, independent development and support teams that can act within a small and well understood context, empowered to work more independently and more quickly. This shortens development cycle times. Furthermore, service independence facilitates scaling of cloud computing infrastructure to meet service demand among various applications that utilize the service, thereby maintaining service availability in the event of any demand spike.

Service independence also increases an application's resistance to failure. In a monolithic architecture, if a single component fails, it can cause the entire application to fail. With microservices, applications can handle failure of individual services by degrading functionality rather than crashing the entire application.

As briefly mentioned above, a common platform used to provide cloud-based services is Kubernetes, which can coordinate a highly available cluster of connected computers (also referred to as “processing elements” or “hosts”) to work as a single unit. Kubernetes deploys applications packaged in “containers” (e.g., via a “container runtime”) to decouple them from individual computing hosts. Kubernetes abstractions facilitate deploying applications to a cloud-based computing cluster without tying them specifically to individual computing machines. In this manner, containerized applications are more flexible and available than in deployment modes where applications were installed directly onto specific machines. Such containerized applications are referred as “cloud-native” applications.

Currently, cloud-native applications are often developed based on application frameworks that can easily adapt a single cloud computing environment to a wide set of applications, use cases, and/or usage scenarios. For example, such frameworks can be used for pre-defined, off-the-shelf applications as well as custom applications created based on customer-specific needs using software development toolkits.

Thus, an application framework should provide an ecosystem in which vendors, integrators, and customers can collaborate to develop and implement a range of cloud-native applications that can grow according to customer needs. One essential capability for such an ecosystem is monitoring usage of the application framework to understand behavior. Ideally, the monitoring should be able to provide patterns of application usage and load-related statistics. This information can facilitate troubleshooting as well identification of deviations from standard usage patterns, which can be due to breaches in usage protocols, application implementation errors, or merely a new usage pattern that exploits some unknown capability.

Although microservices architectures used in cloud-native applications have many advantages, they also create various problems, issues, and/or difficulties for identifying and classifying application usage patterns.

FIG. 2 shows an exemplary cloud computing environment (200) in which various atomic functions (AFs, 210) of software are executing. Each AF provides some indivisible functionality that can be invoked and/or used by higher-level software in the cloud computing environment. For example, each AF can be a service that provides a particular function, such as services B1-B3 that provide respective functions 1-3 as shown in FIG. 1. In such case, the AFs can include respective APIs that can be invoked by various applications that execute in the cloud computing environment. Each AF may be part of a standard library available to all applications executing in the cloud computing environment or may be custom-developed and accessible only by a subset of applications.

To facilitate usage monitoring, each AF is configured to generate trace records at particular trace points during execution/operation. The trace records are collected by a logging function (220), which writes them into a database (or log, 240). For example, the logging function may subscribe to trace records for particular events associated with the respective AFs, and the AFs notify the logging function with trace records when such events occur. Each trace record is labelled with an associated time and date, which is provided by a real-time clock (230) distributed through the cloud computing environment. For example, the real-time clock can provide a universal time coordinate (UTC) derived from a highly accurate source such as global navigation satellite system (GNSS).

The interaction between the AFs and the logging function can be via API of the logging function, respective APIs of the AFs, or a combination thereof. In some arrangements, the logging function can be merely an API of the database itself.

The arrangement shown in FIG. 2 also includes a monitoring function (250), which accesses the trace records stored in the database. Using these trace records, the monitoring function can perform testing, troubleshooting, and analytics for the respective AFs deployed in the cloud environment.

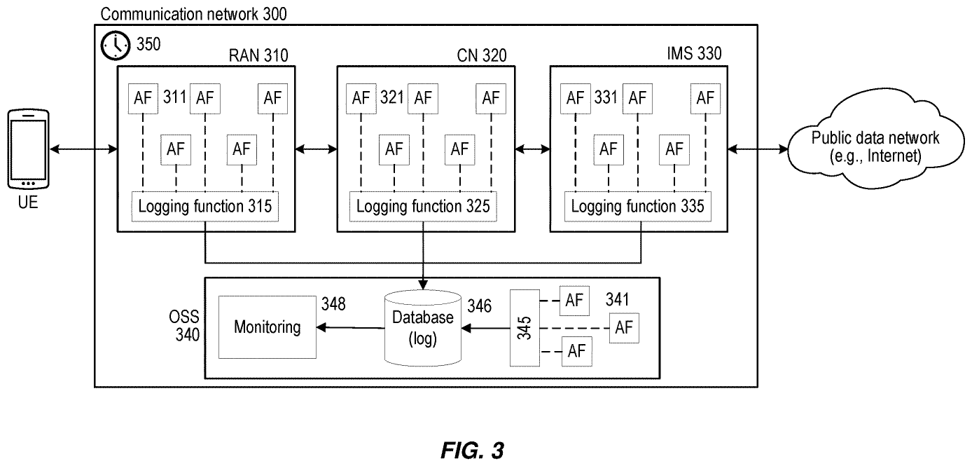

FIG. 3 shows an exemplary communication network (300) that includes a radio access network (RAN, 310), a core network (CN, 320), and an IP multimedia subsystem (IMS, 330). A user equipment (UE) can communicate with a public data network (e.g., Internet) via the communication network. The communication network also includes an operation support system (OSS, 340), but alternately the OSS can be separate from the communication network.

Each of the RAN, CN, IMS, and OSS domains includes various AFs (311, 321, 331, 341 respectively) and a logging function (315, 325, 335, 345 respectively). Each AF provides some indivisible functionality that can be invoked and/or used by higher-level software in the communication network. For example, each AF can be a service that provides a particular function, such as services B1-B3 that provide respective functions 1-3 as shown in FIG. 1. In such case, the AFs can include respective APIs that can be invoked by various applications that execute in the communication network. Each AF may be part of a standard library available to all applications executing in the communication network or may be custom-developed and accessible only by some subset of applications.

To facilitate monitoring, each AF is configured to generate trace records at particular trace points during execution/operation. The trace records are collected by the logging functions for the respective network domains, which write them into a database (or log, 346) in the OSS. For example, the respective logging functions may subscribe to trace records for particular events associated with their respective AFs, which notify the logging functions with trace records when such events occur. Each trace record is labelled with an associated time and date, which is provided by a real-time clock (350) distributed through the communication network. For example, the real-time clock can provide a UTC derived from a highly accurate source such as GNSS.

The interaction between the AFs and the logging function in each network domain can be via API of the logging function, respective APIs of the AFs, or a combination thereof. In some arrangements, the logging functions can be merely APIs of the database itself. In some arrangements, the domain-specific logging functions can be replaced by a single, network-wide logging function.

The OSS also includes a monitoring function (348), which accesses the trace records stored in the database. Using these trace records, the monitoring function can perform testing, troubleshooting, and analytics for the respective AFs deployed in the communication network.

As an illustrative examples, the communication network shown in FIG. 3 can be a 5G network, such that the RAN is a Next Generation RAN (NG-RAN) and the CN is a 5G Core (5GC). An NG-RAN can include gNodeBs (gNBs) and next-generation eNodeBs (ng-eNBs) that are interconnected with each other via respective Xn interfaces. The gNBs and ng-eNBs are also connected via the NG interfaces to the 5GC, more specifically to the Access and Mobility Management Functions (AMFs) via respective NG-C interfaces and to the User Plane Functions (UPFs) via respective NG-U interfaces. Moreover, the AMFs can communicate with one or more policy control functions (PCFs) and network exposure functions (NEFs) in the 5GC.

Each gNB can support the NR radio interface including frequency division duplexing (FDD), time division duplexing (TDD), or a combination thereof. Each ng-eNB can support the fourth generation (4G) Long-Term Evolution (LTE) radio interface. Unlike conventional LTE eNBs, however, ng-eNBs connect to the 5GC via the NG interface. Each of the gNBs and ng-eNBs can serve a geographic coverage area including one more cells. Depending on the cell in which it is located, a UE can communicate with the gNB or ng-eNB serving that cell via the NR or LTE radio interface, respectively.

In 5GC, traditional peer-to-peer interfaces and protocols found in earlier-generation networks are modified and/or replaced by a Service Based Architecture (SBA) in which Network Functions (NFs) provide one or more services to one or more service consumers. This can be done, for example, by Hyper Text Transfer Protocol/Representational State Transfer (HTTP/REST) application programming interfaces (APIs). In general, the various services are self-contained functionalities that can be changed and modified in an isolated manner without affecting other services.

Furthermore, the services are composed of various “service operations”, which are more granular divisions of the overall service functionality. The interactions between service consumers and producers can be of the type “request/response” or “subscribe/notify”. In the 5G SBA, network repository functions (NRF) allow every network function to discover the services offered by other network functions, and Data Storage Functions (DSF) allow every network function to store its context. This 5G SBA model is based on principles including modularity, reusability and self-containment of NFs, which can enable network deployments to take advantage of the latest virtualization and software technologies.

IMS is an architectural framework for delivering multimedia services to wireless devices based on Internet-centric protocols. IMS was originally specified by 3GPP in Release 5 (Rel-5) as a technology for evolving mobile networks beyond GSM, e.g., for delivering Internet services over GPRS. IMS has evolved in subsequent releases to support other access networks and a wide range of services and applications.

At a high-level, IMS functionality can be sub-divided into two types: control and media, and application enablers. The control functionality comprises Call Session Control Function (CSCF) and Home Subscriber Server (HSS). The CSCF is used for session control for devices and applications that are using the IMS network. Session control includes the secure routing of the session initiation protocol (SIP) messages, subsequent monitoring of SIP sessions, and communicating with a policy architecture to support media authorization. CSCF functionality can also be divided into Proxy CSCF (P-CSCF), Serving CSCF (S-CSCF), and Interrogating CSCF (I-CSCF).

CSCF also interacts with the HSS, which is the master database containing user and subscriber information to support the network entities handling calls and sessions. For example, HSS provides functions such as identification handling, access authorization, authentication, mobility management (e.g., which session control entity is serving the user), session establishment support, service provisioning support, and service authorization support.

A Media Resource Function (MRF) can provide media services in a user's home network and can manage and process media streams such as voice, video, speech-to-text, and real-time transcoding of multimedia data. A WebRTC Gateway allows native- and browser-based devices to access services in the network securely.

In the communication network shown in FIG. 3, the available features and protocols can vary significantly between different network (or operator) deployments depending on various factors such as:
technology composing a communication network being managed;
multi-vendor architecture, e.g., which component is provided by which vendor, integration, etc.;
mixture of off-the-shelf and custom applications being used;
operator internal organization;
interaction with business support system (BSS) of the communication network being managed,
computing platform in which the RAN, CN, IMS, and/or OSS is implemented, e.g., proprietary server farm, private cloud, public cloud, etc.

In other words, some AFs may be used in all deployments (mandatory) and others may be optional, that can interact to implement pre-defined, off-the-shelf higher-level functions. Moreover, available features and protocols can be expanded over time based on software development kits from which new applications and use cases can be developed. As such, additional AFs used by these new applications and use cases may be incorporated into the communication network. More generally, there is a need for a healthy software eco-system where network vendors, integrators, and customers (e.g., operators) work together to produce a comprehensive set of applications based on an underlying product framework.

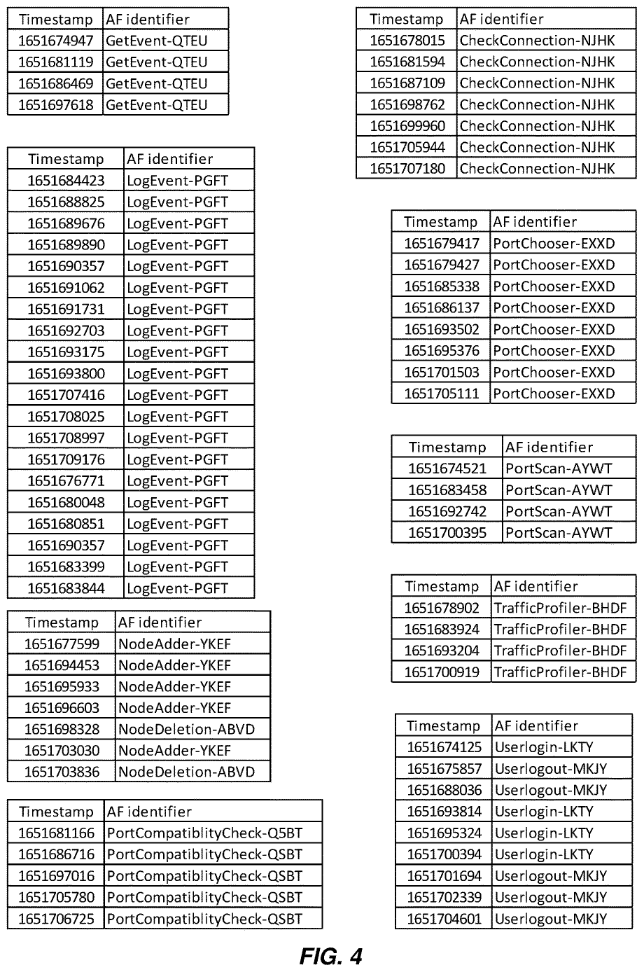

FIG. 4 shows exemplary trace records generated by various AFs (e.g., services) executing in the communication network shown in FIG. 3. For example, these trace records can be stored in the database, such as discussed above. Each trace record entry includes a timestamp and an AF identifier. Each timestamp indicates the actual time (e.g., UTC) at which the associated event occurred. Each trace record is in chronological order based on increasing timestamp values.

Each AF identifier can be assigned during AF development or deployment so as to be to be unique among AFs of the communication network. For example, a “unique identifier” distributor or a “identifier duplication detector” could be employed to avoid the risk of different AFs using the same AF identifier. Although not shown, each trace record entry can also include one or more parameters used by the AF for the event (e.g., source node X, destination node Y) and/or a description message associated with the event (e.g., “link creation request created”).

Note that certain trace records include multiple AF identifiers associated with related AFs or events (e.g., “Userlogin-LKTY” and “Userlogout-MKJY”). This is done for convenience only.

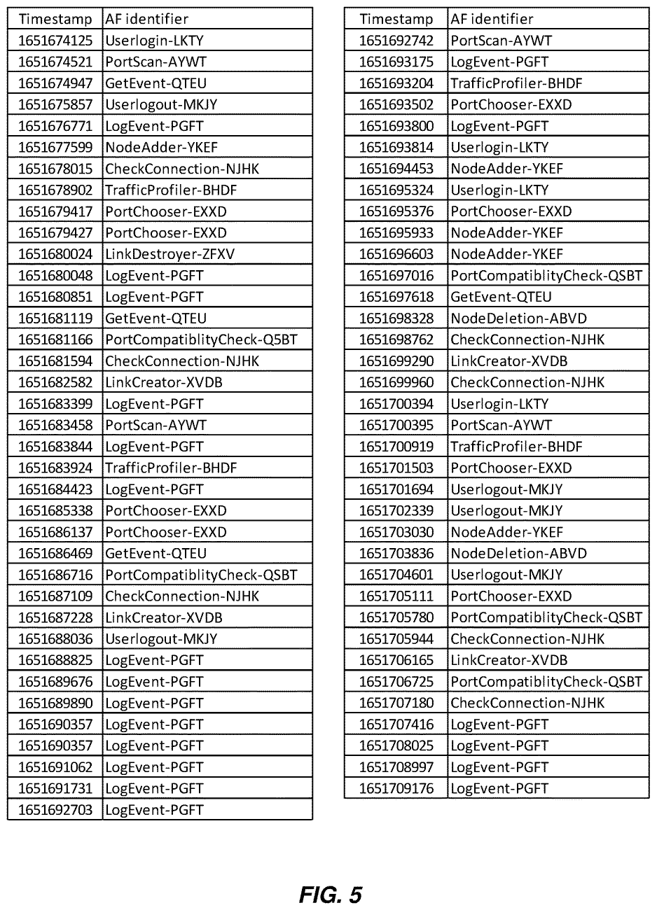

FIG. 5 shows a merge of the AF trace records shown in FIG. 4, arranged in chronological order based on increasing timestamp values. Note that the top-most timestamp in the right column follows the bottom-most timestamp in the left column.

Although the OSS monitoring function shown in FIG. 3 can access the AF trace records in chronological order from the database in which they are stored, the form of the trace records introduces various problems and/or difficulties for testing, troubleshooting, and analytics. In particular, the unclear relationship between the AFs (e.g., services) and high-level applications that utilize the services makes application flows and usage scenarios much more difficult to analyze. Moreover, AF trace records in a large network can include a very large amount of data needing to be analyzed, which may be subject to privacy regulations and must be kept secure against inadvertent or malicious disclosure.

Put more simply, while the monitoring function can see the activities of individual AFs from the trace records, it has limited or no visibility into which higher-level applications are using the AFs, and which usage scenarios are involved. Thus, the monitoring function is unable to determine interactions between multiple applications and/or within a single application that uses AFs in multiple network domains (e.g., RAN and CN). Furthermore, the monitoring function is unable to determine whether cloud computing resources of the communication network are being used optimally and/or efficiently, i.e., based on application-level needs. This limited visibility into application-level behavior inhibits tracing, troubleshooting, and identification of standard usage patterns and deviations therefrom.

Embodiments of the present disclosure address these and other problems, issues, and/or difficulties by providing techniques whereby each AF (e.g., some indivisible functionality, such as a service, that can be invoked and/or used by higher-level software) is assigned a unique identifier. As different software applications execute in a multi-application environment (e.g., cloud infrastructure, 5G network, etc.), each invocation of an AF by one of the applications causes the associated AF identifier to be logged together with an AF invocation time. Subsequently, pattern analysis and/or recognition can be applied to the log to identify recurrent AF patterns that can correspond to an application and/or use case. In particular, each pattern comprises a sequence of AF invocations (with corresponding AF identifiers) that are sufficiently proximate in time to be associated with a single instance of the corresponding application and/or use case. Each AF pattern can also be assigned an AF pattern identifier (also referred to as a “use case tag”), which can be in a form that is easily spotted and/or understood by humans.

These embodiments can provide various benefits and/or advantages. For example, embodiments can be used in a system, product, and/or software development phase for automated testing to identify to identify standard patterns and determine pre-defined use cases according to system, product, and/or software specifications. Identifying pre-defined use cases in this manner can simplify and/or improve efficiency of the subsequent testing phase by facilitating tracing based on easy-to-read use case tags and identification of deviations that can be caused by application errors or exceptions.

As another example, embodiments can be used during system operation (“run-time phase”) to identify use cases based on actual end user patterns, as well as possible misuses of the system. The use cases identified during system operation may include the pre-defined use cases identified during the development phase, as well as other use cases not previously identified. This is beneficial since each system that uses the same underlying AFs may be deployed in different ways by different customers (e.g., 5G operators) according to different needs, so some latent end-to-end (E2E) use cases may be unknown at the time of development and testing. Moreover, use of embodiments regularly during system operation can detect new use cases or variants of existing use cases that evolve over time due to changes in customer needs and/or requirements placed on the system (e.g., additional traffic). Embodiments can also distinguish these new/evolved use cases from system misuse and error conditions based on validation.

In this manner, embodiments can improve system supportability by facilitating easier human analysis of logs based on use case tags that are automatically assigned. Additionally, embodiments can improve system serviceability by identifying new uses cases that are driven by system flexibility and customer adaptations. Furthermore, embodiments limit the amount of data needed to perform system supportability and serviceability, thereby reducing the security risks that come with exposing sensitive system performance information for tracing and analysis. Additionally, embodiments can improve efficiency of system audits used to collect information needed to determine resource needs for (e.g., cloud) platform sizing purposes.

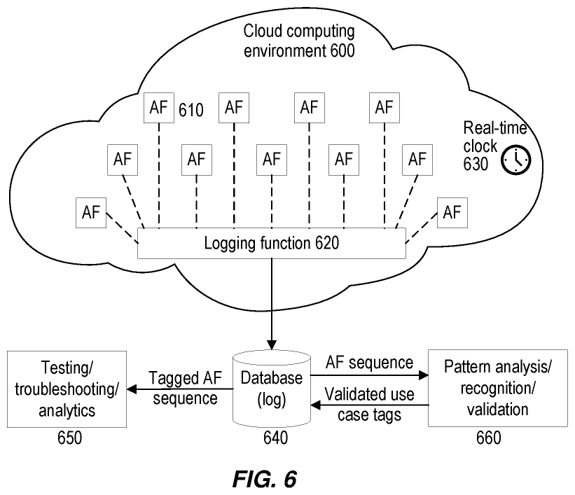

FIG. 6 shows an exemplary computing environment in which some embodiments of the present disclosure can be implemented. The system shown in FIG. 6 includes a cloud computing environment (600, also referred to as “cloud” for brevity) in which a plurality of atomic software functions (AFs, 610) are instantiated for execution. The cloud also includes a logging function (620) that is operably coupled to the AFs, and a real-time clock 630 that is operably coupled to the AFs and/or the logging function. The real-time clock may provide a universal time coordinate (UTC) to the logging function and/or AFs. Although FIG. 6 shows a centralized logging function separate from the AFs, this is only exemplary and the logging function can also be distributed across the AFs.

The system in FIG. 6 also includes a database (640, or log), a pattern analysis/recognition/validation (PARV) function (650), and a testing/troubleshooting/analytics (TTA) function (660). Although shown outside of the cloud in FIG. 6, one or more of the log, the PARV function, and the TTA function can be located within the cloud.

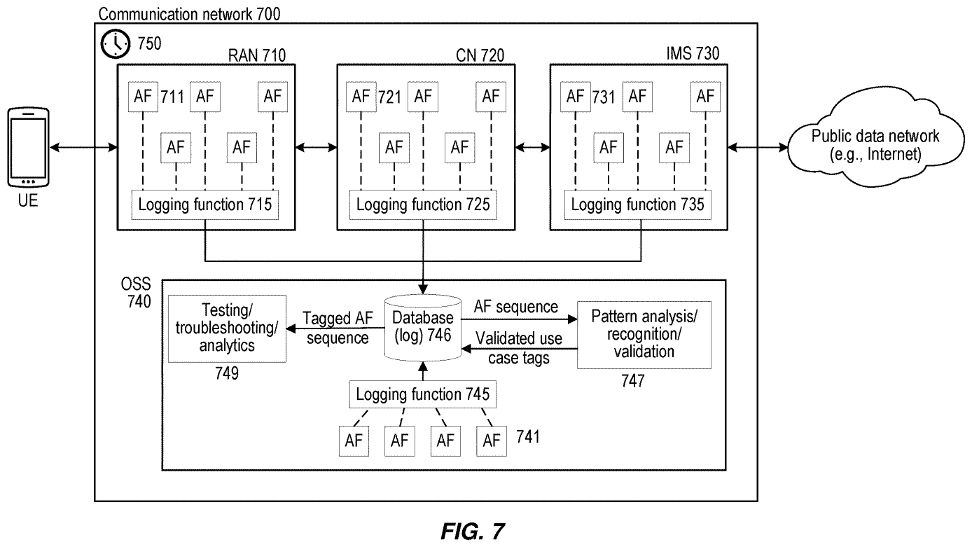

FIG. 7 shows an exemplary communication network (700) in which some embodiments of the present disclosure can be implemented. The communication network shown in FIG. 7 includes four domains—RAN (710), CN (720), IMS (730), and OSS (740)—and a real-time clock (750). As illustrated in FIG. 7, the RAN, CN, and IMS domains can transport data (e.g., for an application or OTT service) between a UE and a public data network (e.g., Internet). The OSS shown in FIG. 7 also includes a database (746, or log), a PARV function (747), and a TTA function (749).

The RAN includes a plurality of AFs (711) that are instantiated for execution, as well as a logging function (715). Likewise, the CN includes a plurality of other AFs (721) that are instantiated for execution, as well as a logging function (725). Similarly, the IMS includes a plurality of other AFs that are instantiated for execution, as well as a logging function (735). Also, the OSS includes a plurality of other AFs that are instantiated for execution, as well as a logging function (745). Note that some or all the AFs may be instantiated in a cloud environment such as shown in FIG. 6. Thus, the communication network shown in FIG. 7 can be seen as a type of computing environment, similar to the computing environment shown in FIG. 6.

Similar to the arrangement shown in FIG. 3, the interaction between the AFs and the logging function in each network domain can be via API of the logging function, respective APIs of the AFs (e.g., logging function 712 across AFs 711), or a combination thereof. In some arrangements, the logging functions can be merely APIs of the database itself. In some arrangements, the domain-specific logging functions can be replaced by a single, network-wide logging function.

Note that the PARV functions shown in FIGS. 6-7 may be examples of a monitoring function for a computing environment, such as discussed above. Also, each combination of the PARV function, the database, and the TTA function shown in FIGS. 6-7 may be other examples of a monitoring function for a computing environment.

According to various embodiments, including those illustrated by FIGS. 6-7, each time an AF is invoked, the following information associated with the invocation is logged into a database (e.g., 640 in FIG. 6, 741 in FIG. 7):
AF identifier, which is unique within the system and can be assigned during system development, system testing, and/or system deployment.
AF invocation time (e.g., UTC timestamp);
AF operation description; and
AF operational parameters.

The precise format used for logged entries is flexible so long as it is consistent and each entry can be read by the PIV function. For example, the following is an example log entry:
AF Identifier=LinkCreator-UAXBV
AF invocation time=2022 Mar. 2 13:12:58.22
AF operation description=Link creation request created.
AF operational parameters=From node XXX.XXXX to node YYYY.YYY,
   which would appear in comma-separated format as follows:
LinkCreator-UAXBV, 2022 Mar. 2 13:12:58.22, Link creation request created, from node XXX.XXXX to node YYYY.YYY

The PARV function obtains the logged AF sequence from the database and performs pattern analysis and/or recognition to identify recurrent AF patterns that can correspond to an application and/or use case. For example, the PARV function can apply artificial intelligence/machine learning (AI/ML) algorithms to the logged AF sequence to identify the recurrent AF pattern, as explained in more detail below.

Upon identifying a candidate recurrent pattern, the PARV function assigns a temporary pattern identifier and submits the candidate recurrent pattern to a validation authority, which could be a human validator, an AI/ML (or other software) validation algorithm, or a combination thereof. The validation authority inspects the candidate recurrent pattern and determines whether its constituent AFs correspond to a higher-level logical activity or operation, such as creation of a link across network elements, creation of a new user, scheduling of a recurrent backup job, etc. For example, the validation authority may compare the candidate recurrent pattern to AF patterns for pre-defined or identified use cases, e.g., for similarities. The validation engine outputs one of the following indicators:
Pattern is not valid, i.e., validation authority does not recognize any higher-level logical activity or operation. This may occur, for example, when the candidate recurrent pattern is an artifact of the AI/ML algorithm used to identify it, or when the recurrence of the pattern is merely random. In any event, the PARV function discards this candidate recurrent pattern. In some embodiments, the PARV function (or validation engine) can save this invalid pattern to a “rejected list” that it refers to when validating subsequent candidate recurrent pattens.
Pattern is valid, i.e., validation authority recognizes a valid higher-level logical activity or operation. The PARV function assigns a unique use case tag to this candidate recurrent pattern and stores the assigned use case tag in the database in association with the AF entries that comprise individual instances of the identified use case. The information stored in this manner is referred to as a “tagged AF sequence.”
Pattern is partially valid, i.e., validation authority recognizes a higher-level logical activity that is either incomplete or includes extraneous AF entries (e.g., noise). In such case, the PARV functions edits the pattern by adding missing AF entries or removing extraneous AF entries. The edited pattern is submitted for re-validation, which may occur until either the validation authority is satisfied or no validation can be obtained after some predetermined number of attempts.

In general, pattern editing requires an in-depth understanding of available applications and/or use cases and may be most feasible when the validation authority is advanced AI or a human (with or without AI assistance).

The TTA function reads the tagged AF sequences from the database and performs TTA-related activities such as benchmarking, automated testing, system audits for resource needs, identifying pre-defined or non-pre-defined use cases, identifying system misuses and/or error conditions, etc.

In some embodiments, the PARV function can included an identifier duplication detector that searches for the same AF identifier being used by different AFs. This event can be detected, for example, based on discrepancies between other AF information logged together with the AF identifier. If such an event is detected, the PARV function can generate an exception or error message that notifies a human operator of the identifier duplication. If done during development or testing phase, the identifier duplication can be corrected by changing one of the AFs to use a different identifier, after which logging of AF invocation can be performed again if necessary.

In some embodiments, the PARV function can also identify a higher-level (or more abstract) use case based on tagged use cases identified from recurrent AF patterns. For example, if the PARV function identifies a higher-level recurrent pattern of tagged use case 2 proximately after tagged use case 1, then the PARV function can validate whether this combination of two use cases corresponds to a higher-level use case, and assign another use case tag (e.g., use case 3) accordingly.

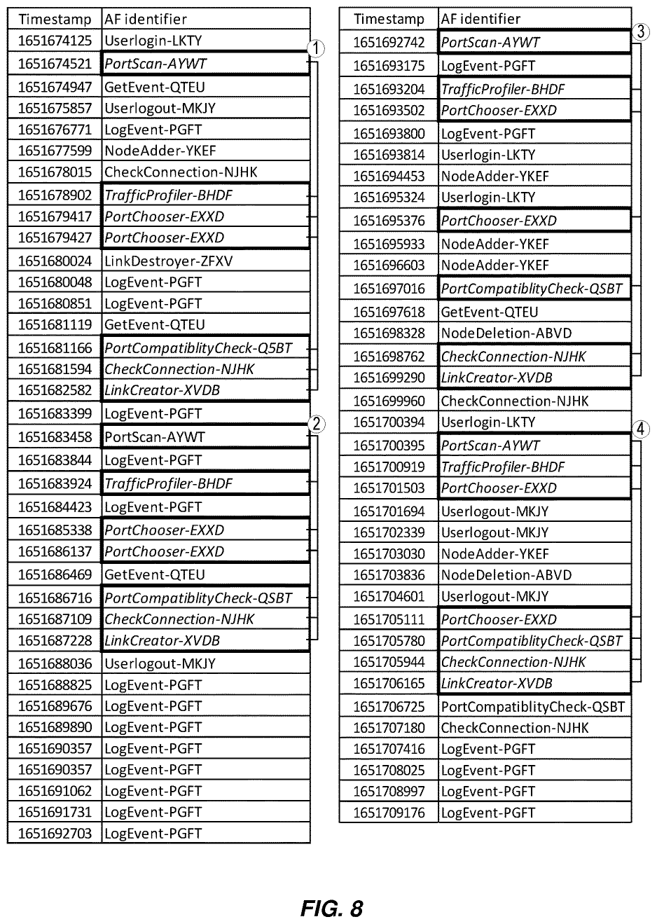

FIG. 8 illustrates operation of some embodiments of the present disclosure in the context of the chronologically ordered AF sequence shown in FIG. 5. For example, the AF sequence shown in FIG. 8 can be logged in either of the databases shown in FIGS. 6-7. Each sequence entry includes an AF identifier (e.g., “Userlogin-LKTY”) and a corresponding AF invocation timestamp (e.g., 1651674125) that is derived from a UTC source, as well as other fields discussed above.

After obtaining the AF sequence from the database, the PARV function analyses the AF sequence and detects the following candidate recurrent pattern:
PortScan-AYWT
TrafficProfiler-BHDF
PortChooser-EXXD.
PortChooser-EXXD
PortCompatiblityCheck-Q5BT.
CheckConnection-NJHK
LinkCreator-XVDB

In particular, the PARV function identifies four instances of this candidate recurrent pattern, identified by circled numerals 1-4 in FIG. 8. Although the four instances of the candidate recurrent pattern consist of the same AF identifiers in the same chronological order, each instance (e.g., 1) includes different chronologically intervening non-pattern AF identifiers than other instances (e.g., 2-4).

The PARV function validates that the candidate recurrent pattern corresponds to a high-level operation associated with link creation between nodes of the communication network, and then assigns the recurrent pattern the use case tag “LINKCREATION”. Each use case tag assignment may be pre-defined (e.g., by a provider of an application corresponding to the use case) or autogenerated by the PARV function.

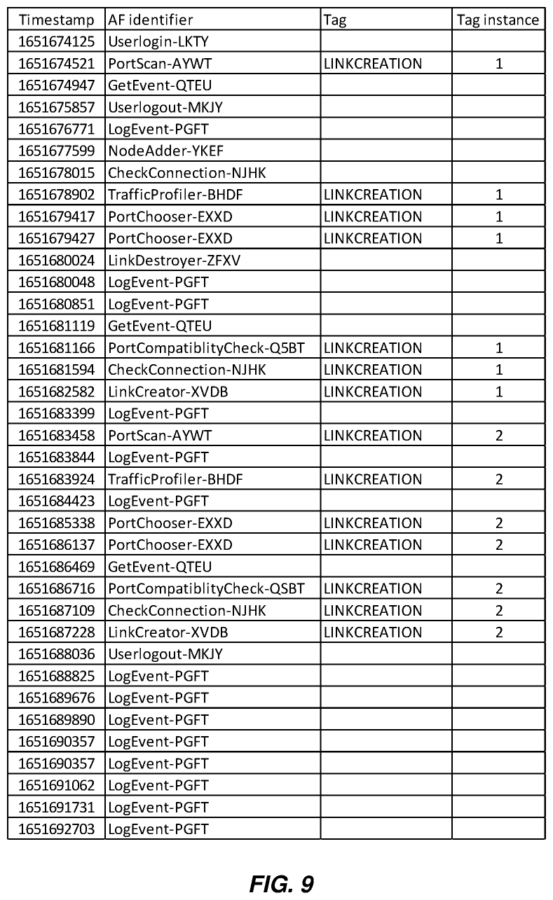

The PARV function then stores the validated use case tag in the databased in association with each AF sequence from which it was derived. FIG. 9 shows an exemplary data structure for storage of use case tags in association with AF sequences, according to some embodiments of the present disclosure. In this example, the use case tag LINKCREATION is appended and/or associated with each AF record determined by the PARV function to be part of the corresponding recurrent pattern. Additionally, in some embodiments, a tag instance can also be appended to and/or associated with each AF record determined by the PARV function to be part of the corresponding recurrent pattern. Note that the data structure shown in FIG. 9 represents only part of the AF sequence, with the remainder omitted for brevity.

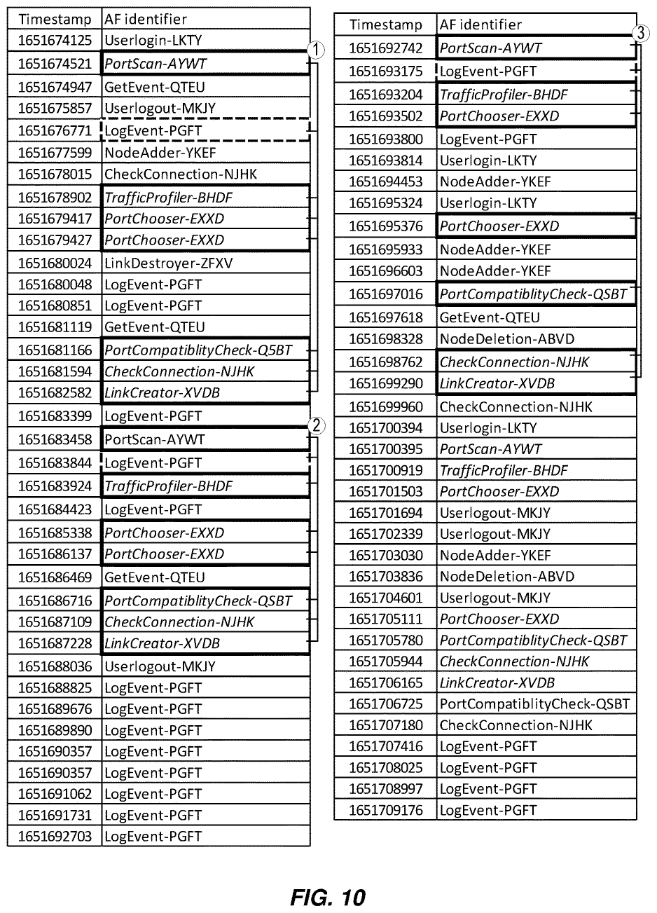

FIG. 10 illustrates operation of other embodiments of the present disclosure in the context of the chronologically ordered AF sequence shown in FIG. 5. Similar to FIG. 8, the AF sequence shown in FIG. 10 can be logged in either of the databases shown in FIGS. 6-7. Each sequence entry includes an AF identifier (e.g., “Userlogin-LKTY”) and a corresponding AF invocation timestamp (e.g., 1651674125) that is derived from a UTC source, as well as other fields discussed above.

After obtaining the AF sequence from the database, the PARV function analyses the AF sequence and detects the following candidate recurrent pattern:
PortScan-AYWT
LogEvent-PGFT
TrafficProfiler-BHDF.
PortChooser-EXXD.
PortChooser-EXXD
PortCompatiblityCheck-Q5BT.
CheckConnection-NJHK
LinkCreator-XVDB

Note that this candidate recurrent pattern is identical to the one discussed above in relation to FIG. 8 except for insertion of the additional AF identifier “LogEvent-PGFT” into the second position of the AF sequence. In this case, the PARV function identifies three instances of this candidate recurrent pattern, identified by circled numerals 1-3 in FIG. 10. Although the three instances of the candidate recurrent pattern consist of the same AF identifiers in the same chronological order, each instance (e.g., 1) includes different intervening non-pattern AF identifiers than other instances (e.g., 2-3).

In contrast to the candidate recurrent pattern shown in FIG. 8, the PARV function does not validate that the candidate recurrent pattern shown in FIG. 10 corresponds to a high-level operation. Although the PARV function may detect that a portion of the candidate recurrent pattern corresponds to the high-level operation of link creation between nodes of the communication network, the PARV function determines that the “LogEvent-PGFT” is an alarm or other event that is unrelated to this high-level operation. Accordingly, the PARV function does not assign a use case tag, does not update the AF sequence stored in the databased, and in cases may store the candidate recurrent pattern on a “rejected list” for future use.

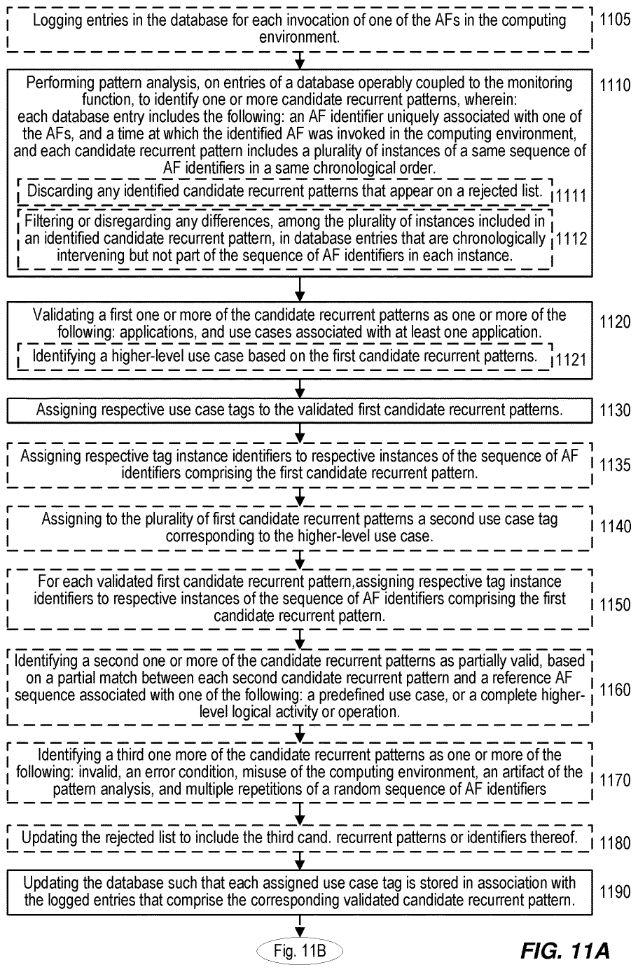

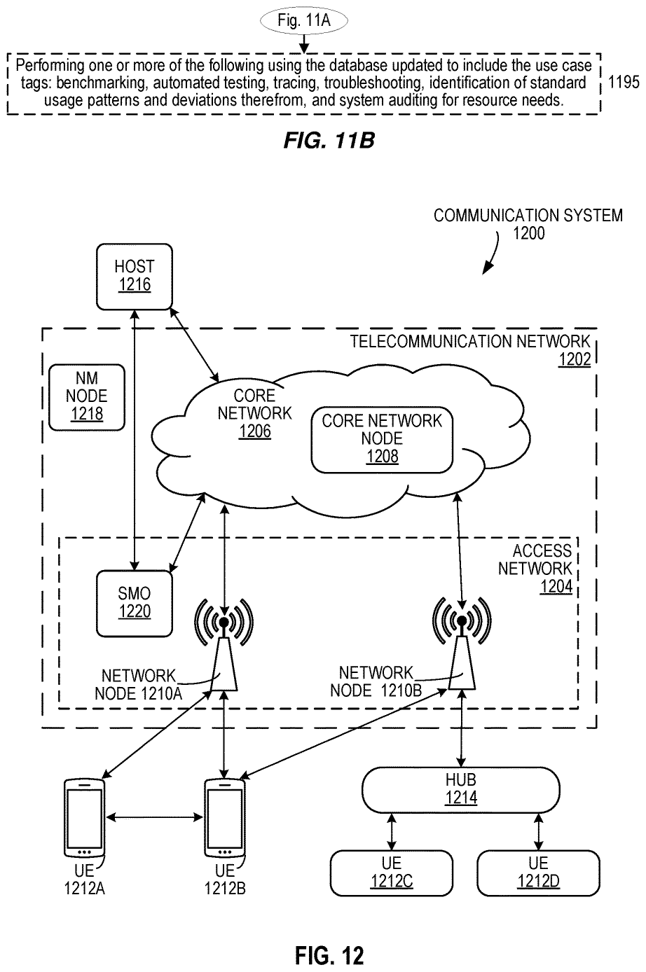

Various features of the embodiments described above correspond to various operations illustrated in FIG. 11, which includes FIGS. 11A-B and depicts an exemplary method (e.g., procedure) performed by a monitoring function for a computing environment configured to host a plurality of atomic software functions (AFs) that are usable by applications executing in the computing environment, according to various embodiments of the present disclosure. In other words, various features described below correspond to various embodiments described above. Although FIG. 11 shows specific blocks in a particular order, the operations of the exemplary method can be performed in different orders than shown and can be combined and/or divided into blocks having different functionality than shown. Optional blocks or operations are indicated by dashed lines.

The exemplary method can include the operations of block 1110, where the monitoring function can perform pattern analysis, on entries of a database operably coupled to the monitoring function, to identify one or more candidate recurrent patterns. Each database entry includes the following: an AF identifier uniquely associated with one of the AFs, and a time at which the identified AF was invoked in the computing environment. Each candidate recurrent pattern includes a plurality of instances of a same sequence of AF identifiers in a same chronological order.

The exemplary method can also include the operations of block 1120, where the monitoring function can validate a first one or more of the candidate recurrent patterns as one or more of the following: applications, and use cases associated with at least one application. The exemplary method can also include the operations of block 1130, where the monitoring function can assign respective use case tags to the validated first candidate recurrent patterns. The exemplary method can also include the operations of block 1190, where the monitoring function can update the database such that each assigned use case tag is stored in association with the database entries that are associated with the corresponding validated candidate recurrent pattern.

In some embodiments, validating the first candidate recurrent patterns in block 1120 is based on a complete match between each first candidate recurrent pattern and a reference AF sequence associated with one of the following: a predefined use case, or a complete higher-level logical activity or operation.

In some embodiments, a plurality of first candidate recurrent patterns are validated and assigned respective first use case tags and validating the first candidate recurrent patterns in block 1120 includes the operations of sub-block 1121, where the monitoring function can identify a higher-level use case based on the plurality of first candidate recurrent patterns. In such case, the exemplary method can also include the operations of block 1140, where the monitoring function can assign to the plurality of first candidate recurrent patterns a second use case tag corresponding to the higher-level use case.

In some embodiments, the exemplary method can also include the operations of block 1160, where the monitoring function can identify a second one or more of the candidate recurrent patterns as partially valid, based on a partial match between each second candidate recurrent pattern and a reference AF sequence associated with one of the following: a predefined use case, or a complete higher-level logical activity or operation. In some of these embodiments, each partial match is based on one or more of the following differences between a candidate recurrent pattern and a reference AF sequence:
each AF sequence in the candidate recurrent pattern is missing a same one or more entries in the reference AF sequence; and
each AF sequence in the candidate recurrent pattern includes a same one or more entries that are missing from the reference AF sequence.

In some embodiments, the exemplary method can also include the operations of block 1170, where the monitoring function can identify a third one more of the candidate recurrent patterns as one or more of the following: invalid, an error condition, misuse of the computing environment, an artifact of the pattern analysis, and multiple repetitions of a random sequence of AF identifiers. In some of these embodiments, performing pattern analysis in block 1110 includes the operations of sub-block 1111, where the monitoring function can discard any of the identified candidate recurrent patterns that appear on a rejected list. In such case, the exemplary method can also include the operations of block 1180, where the monitoring function can update the rejected list to include the third candidate recurrent patterns or identifiers thereof (e.g., that were identified in block 1170).

Note that the operations of blocks 1120, 1160, and 1170 are neither inter-dependent nor mutually exclusive. For example, the monitoring function may identify the second candidate recurrent patterns that are partially valid and/or the third candidate recurrent patterns that are invalid without validating any of the candidate recurrent patterns, such as when no fully valid candidate recurrent patterns were identified in block 1110.

In some embodiments, the exemplary method can also include the operations of block 1135, where for each validated first candidate recurrent pattern, the monitoring function can assign respective tag instance identifiers to respective instances of the sequence of AF identifiers comprising the first candidate recurrent pattern. In such case, the database is further updated (e.g., in block 1190) such that the respective tag instance identifiers are stored in association with the database entries that are associated with the corresponding validated candidate recurrent pattern. FIG. 9 shows an example of these embodiments.

In some embodiments, the exemplary method can also include the operations of block 1195, where the monitoring function can perform one or more of the following using the database updated to include the use case tags (e.g., in block 1190): benchmarking, automated testing, tracing, troubleshooting, identification of standard usage patterns and deviations therefrom, and system auditing for resource needs.

In some embodiments, the exemplary method can also include the operations of block 1105, where the monitoring function can log entries in the database for each invocation of one of the AFs in the computing environment. In such case, pattern analysis is performed on the logged database entries. These embodiments are applicable when the monitoring function includes a logging function.

In other embodiments, each database entry can be logged by one of the following: a logging function separate from the monitoring function, an application programming interface (API) of the AF identified in the database entry, an API of the database.

In some embodiments, each database entry also includes one or more of the following associated with the identified AF: an operation description, and operational parameters used for invocation. In some embodiments, each AF identifier and each use case tag is in a human-readable format (e.g., in the database).

In some embodiments, performing pattern analysis on entries of the database to identify one or more candidate recurrent patterns in block 1110 includes the operations of sub-block 1112, where the monitoring function can filter or disregard any differences, among the plurality of instances included in an identified candidate recurrent pattern, in database entries that are chronologically intervening but not part of the sequence of AF identifiers in each instance. As an example, each of the four numbered instances in the recurrent pattern in FIG. 8 has a different group of chronologically intervening (i.e., based on timestamp) AF identifiers that are not part of recurrent pattern.

In some embodiments, the computing environment is associated with a communication network that includes at least two of the following domains: radio access network (RAN), core network (CN), IP multimedia system (IMS), and operations support system (OSS). In such embodiments, each of the plurality of AFs is hosted by one of the domains of the communication network. FIG. 7 shows an example of these embodiments.

Although various embodiments are described above in terms of methods, techniques, and/or procedures, the person of ordinary skill will readily comprehend that such methods, techniques, and/or procedures can be embodied by various combinations of hardware and software in various systems, communication devices, computing devices, control devices, apparatuses, non-transitory computer-readable media, computer program products, etc.

FIG. 12 shows an example of a communication system 1200 in accordance with some embodiments. In this example, the communication system 1200 includes a telecommunication network 1202 that includes an access network 1204, such as a radio access network (RAN), and a core network 1206, which includes one or more core network nodes 1208. In some embodiments, telecommunication network 1202 can also include one or more Network Management (NM) nodes 1218, which can be part of an operation support system (OSS), a business support system (BSS), and/or an OAM system. The NM nodes can monitor and/or control operations of other nodes in access network 1204 and core network 1206. Although not shown in FIG. 12, NM node 1218 is configured to communicate with other nodes in access network 1204 and core network 1206 for these purposes.

Access network 1204 includes one or more access network nodes, such as network nodes 1210a and 1210b (one or more of which may be generally referred to as network nodes 1210), or any other similar 3GPP access node or non-3GPP access point. The network nodes 1210 facilitate direct or indirect connection of UEs, such as by connecting UEs 1212a-d (one or more of which may be generally referred to as UEs 1212) to the core network 1206 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1200 may include any number of wired or wireless networks, network nodes, UEs, and/or any other components or systems that may facilitate or participate in the communication of data and/or signals whether via wired or wireless connections. The communication system 1200 may include and/or interface with any type of communication, telecommunication, data, cellular, radio network, and/or other similar type of system.

The UEs 1212 may be any of a wide variety of communication devices, including wireless devices arranged, configured, and/or operable to communicate wirelessly with the network nodes 1210 and other communication devices. Similarly, the network nodes 1210 are arranged, capable, configured, and/or operable to communicate directly or indirectly with the UEs 1212 and/or with other network nodes or equipment in the telecommunication network 1202 to enable and/or provide network access, such as wireless network access, and/or to perform other functions, such as administration in the telecommunication network 1202.

In the depicted example, the core network 1206 connects the network nodes 1210 to one or more hosts, such as host 1216. These connections may be direct or indirect via one or more intermediary networks or devices. In other examples, network nodes may be directly coupled to hosts. The core network 1206 includes one more core network nodes (e.g., core network node 1208) that are structured with hardware and software components. Features of these components may be substantially similar to those described with respect to the UEs, network nodes, and/or hosts, such that the descriptions thereof are generally applicable to the corresponding components of the core network node 1208. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1216 may be under the ownership or control of a service provider other than an operator or provider of the access network 1204 and/or the telecommunication network 1202, and may be operated by the service provider or on behalf of the service provider. The host 1216 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

In some embodiments, access network 1204 can include a service management and orchestration (SMO) system or node 1220, which can monitor and/or control operations of the access network nodes 1210. This arrangement can be used, for example, when access network 1204 utilizes an Open RAN (O-RAN) architecture. SMO system 1220 can be configured to communicate with core network 1206 and/or host 1216, as shown in FIG. 12.

In some embodiments, one or more of host 1216, network management node 1218, and SMO system 1220 can be configured to perform various operations of exemplary methods (e.g., procedures) performed by a monitoring function for a computing environment configured to host a plurality of atomic software functions, such as described above in relation to FIGS. 6-11.

As a whole, the communication system 1200 of FIG. 12 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1202 is a cellular network that implements 3GPP standardized features. Accordingly, the telecommunications network 1202 may support network slicing to provide different logical networks to different devices that are connected to the telecommunication network 1202. For example, the telecommunications network 1202 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1212 are configured to transmit and/or receive information without direct human interaction. For instance, a UE may be designed to transmit information to the access network 1204 on a predetermined schedule, when triggered by an internal or external event, or in response to requests from the access network 1204. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1214 communicates with the access network 1204 to facilitate indirect communication between one or more UEs (e.g., UE 1212c and/or 1212d) and network nodes (e.g., network node 1210b). In some examples, the hub 1214 may be a controller, router, content source and analytics, or any of the other communication devices described herein regarding UEs. For example, the hub 1214 may be a broadband router enabling access to the core network 1206 for the UEs. As another example, the hub 1214 may be a controller that sends commands or instructions to one or more actuators in the UEs. Commands or instructions may be received from the UEs, network nodes 1210, or by executable code, script, process, or other instructions in the hub 1214. As another example, the hub 1214 may be a data collector that acts as temporary storage for UE data and, in some embodiments, may perform analysis or other processing of the data. As another example, the hub 1214 may be a content source. For example, for a UE that is a VR headset, display, loudspeaker or other media delivery device, the hub 1214 may retrieve VR assets, video, audio, or other media or data related to sensory information via a network node, which the hub 1214 then provides to the UE either directly, after performing local processing, and/or after adding additional local content. In still another example, the hub 1214 acts as a proxy server or orchestrator for the UEs, in particular in if one or more of the UEs are low energy IoT devices.

The hub 1214 may have a constant/persistent or intermittent connection to the network node 1210b. The hub 1214 may also allow for a different communication scheme and/or schedule between the hub 1214 and UEs (e.g., UE 1212c and/or 1212d), and between the hub 1214 and the core network 1206. In other examples, the hub 1214 is connected to the core network 1206 and/or one or more UEs via a wired connection. Moreover, the hub 1214 may be configured to connect to an M2M service provider over the access network 1204 and/or to another UE over a direct connection. In some scenarios, UEs may establish a wireless connection with the network nodes 1210 while still connected via the hub 1214 via a wired or wireless connection. In some embodiments, the hub 1214 may be a dedicated hub—that is, a hub whose primary function is to route communications to/from the UEs from/to the network node 1210b. In other embodiments, the hub 1214 may be a non-dedicated hub—that is, a device which is capable of operating to route communications between the UEs and network node 1210b, but which is additionally capable of operating as a communication start and/or end point for certain data channels.

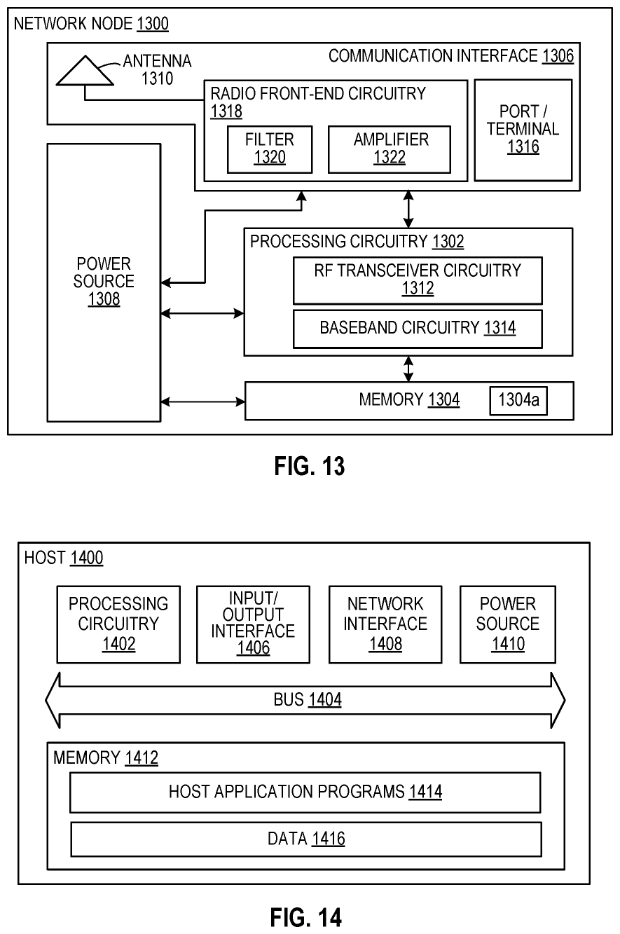

FIG. 13 shows a network node 1300 in accordance with some embodiments. Examples of network nodes include, but are not limited to, access points (e.g., radio access points) and base stations (e.g., radio base stations, Node Bs, eNBs, and gNBs).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

In some embodiments, network node 1300 can be configured to perform various operations of exemplary methods (e.g., procedures) for a monitoring function for a computing environment configured to host a plurality of atomic software functions, such as described above in relation to FIGS. 6-11.

The network node 1300 includes a processing circuitry 1302, a memory 1304, a communication interface 1306, and a power source 1308. The network node 1300 may be composed of multiple physically separate components (e.g., a NodeB component and a RNC component, or a BTS component and a BSC component, etc.), which may each have their own respective components. In certain scenarios in which the network node 1300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1300 may be configured to support multiple radio access technologies (RATs). In such embodiments, some components may be duplicated (e.g., separate memory 1304 for different RATs) and some components may be reused (e.g., a same antenna 1310 may be shared by different RATs). The network node 1300 may also include multiple sets of the various illustrated components for different wireless technologies integrated into network node 1300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1300.

The processing circuitry 1302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1300 components, such as the memory 1304, to provide network node 1300 functionality.

In some embodiments, the processing circuitry 1302 includes a system on a chip (SOC). In some embodiments, the processing circuitry 1302 includes one or more of radio frequency (RF) transceiver circuitry 1312 and baseband processing circuitry 1314. In some embodiments, the radio frequency (RF) transceiver circuitry 1312 and the baseband processing circuitry 1314 may be on separate chips (or sets of chips), boards, or units, such as radio units and digital units. In alternative embodiments, part or all of RF transceiver circuitry 1312 and baseband processing circuitry 1314 may be on the same chip or set of chips, boards, or units.

The memory 1304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1302. The memory 1304 may store any suitable instructions, data, or information, including a computer program, software, an application including one or more of logic, rules, code, tables, and/or other instructions capable of being executed by the processing circuitry 1302 and utilized by the network node 1300. The memory 1304 may be used to store any calculations made by the processing circuitry 1302 and/or any data received via the communication interface 1306. In some embodiments, the processing circuitry 1302 and memory 1304 is integrated.

The communication interface 1306 is used in wired or wireless communication of signaling and/or data between a network node, access network, and/or UE. As illustrated, the communication interface 1306 comprises port(s)/terminal(s) 1316 to send and receive data, for example to and from a network over a wired connection. The communication interface 1306 also includes radio front-end circuitry 1318 that may be coupled to, or in certain embodiments a part of, the antenna 1310. Radio front-end circuitry 1318 comprises filters 1320 and amplifiers 1322. The radio front-end circuitry 1318 may be connected to an antenna 1310 and processing circuitry 1302. The radio front-end circuitry may be configured to condition signals communicated between antenna 1310 and processing circuitry 1302. The radio front-end circuitry 1318 may receive digital data that is to be sent out to other network nodes or UEs via a wireless connection. The radio front-end circuitry 1318 may convert the digital data into a radio signal having the appropriate channel and bandwidth parameters using a combination of filters 1320 and/or amplifiers 1322. The radio signal may then be transmitted via the antenna 1310. Similarly, when receiving data, the antenna 1310 may collect radio signals which are then converted into digital data by the radio front-end circuitry 1318. The digital data may be passed to the processing circuitry 1302. In other embodiments, the communication interface may comprise different components and/or different combinations of components.

In certain alternative embodiments, the network node 1300 does not include separate radio front-end circuitry 1318, instead, the processing circuitry 1302 includes radio front-end circuitry and is connected to the antenna 1310. Similarly, in some embodiments, all or some of the RF transceiver circuitry 1312 is part of the communication interface 1306. In still other embodiments, the communication interface 1306 includes one or more ports or terminals 1316, the radio front-end circuitry 1318, and the RF transceiver circuitry 1312, as part of a radio unit (not shown), and the communication interface 1306 communicates with the baseband processing circuitry 1314, which is part of a digital unit (not shown).

The antenna 1310 may include one or more antennas, or antenna arrays, configured to send and/or receive wireless signals. The antenna 1310 may be coupled to the radio front-end circuitry 1318 and may be any type of antenna capable of transmitting and receiving data and/or signals wirelessly. In certain embodiments, the antenna 1310 is separate from the network node 1300 and connectable to the network node 1300 through an interface or port.

The antenna 1310, communication interface 1306, and/or the processing circuitry 1302 may be configured to perform any receiving operations and/or certain obtaining operations described herein as being performed by the network node. Any information, data and/or signals may be received from a UE, another network node and/or any other network equipment. Similarly, the antenna 1310, the communication interface 1306, and/or the processing circuitry 1302 may be configured to perform any transmitting operations described herein as being performed by the network node. Any information, data and/or signals may be transmitted to a UE, another network node and/or any other network equipment.

The power source 1308 provides power to the various components of network node 1300 in a form suitable for the respective components (e.g., at a voltage and current level needed for each respective component). The power source 1308 may further comprise, or be coupled to, power management circuitry to supply the components of the network node 1300 with power for performing the functionality described herein. For example, the network node 1300 may be connectable to an external power source (e.g., the power grid, an electricity outlet) via an input circuitry or interface such as an electrical cable, whereby the external power source supplies power to power circuitry of the power source 1308. As a further example, the power source 1308 may comprise a source of power in the form of a battery or battery pack which is connected to, or integrated in, power circuitry. The battery may provide backup power should the external power source fail.

Embodiments of the network node 1300 may include additional components beyond those shown in FIG. 13 for providing certain aspects of the network node's functionality, including any of the functionality described herein and/or any functionality necessary to support the subject matter described herein. For example, the network node 1300 may include user interface equipment to allow input of information into the network node 1300 and to allow output of information from the network node 1300. This may allow a user to perform diagnostic, maintenance, repair, and other administrative functions for the network node 1300.

FIG. 14 is a block diagram of a host 1400, which may be an embodiment of the host 1216 of FIG. 12, in accordance with various aspects described herein. As used herein, the host 1400 may be or comprise various combinations hardware and/or software, including a standalone server, a blade server, a cloud-implemented server, a distributed server, a virtual machine, container, or processing resources in a server farm. The host 1400 may provide one or more services to one or more UEs.

Host 1400 includes processing circuitry 1402 that is operatively coupled via a bus 1404 to an input/output interface 1406, a network interface 1408, a power source 1410, and a memory 1412. Other components may be included in other embodiments. Features of these components may be substantially similar to those described with respect to the devices of previous figures, such as FIGS. 12 and 13, such that the descriptions thereof are generally applicable to the corresponding components of host 1400.

The memory 1412 may include one or more computer programs including one or more host application programs 1414 and data 1416. In some embodiments, host 1400 can be configured to perform various operations of exemplary methods (e.g., procedures) for a monitoring function for a computing environment configured to host a plurality of atomic software functions, such as described above in relation to FIGS. 6-11.

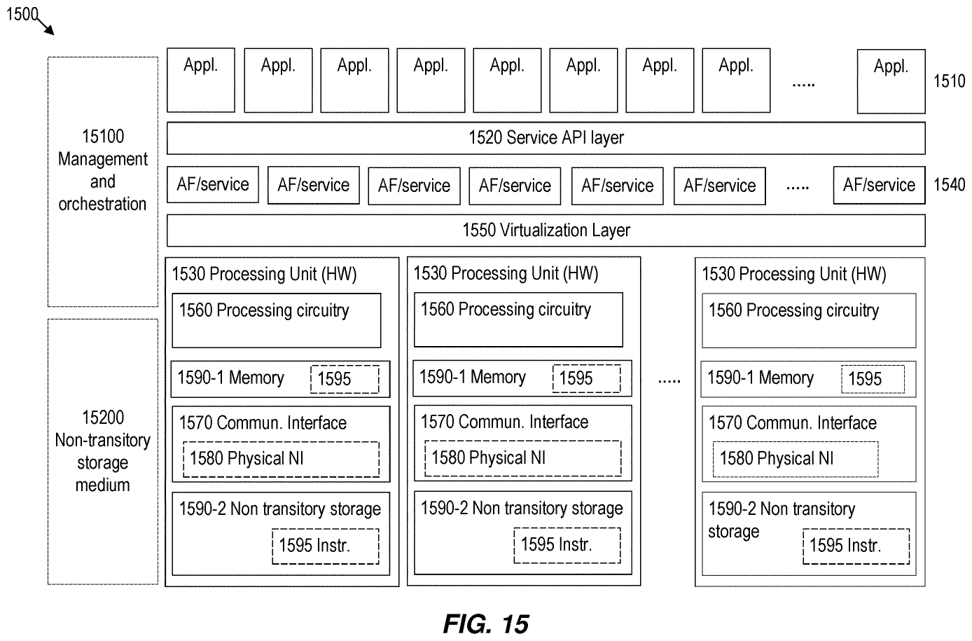

FIG. 15 is a block diagram of an exemplary computing environment (or platform, 1500) in which various embodiments of the present disclosure can be implemented. In the exemplary arrangement shown in FIG. 15, functions are implemented as virtual components executed by one or more virtual machines in computing environment 1500 hosted by a plurality of processing units 1530. In some embodiments, however, such virtual components can be executed by one or more physical computing machines, e.g., without (or with less) virtualization of the underlying resources of processing units 1530.

These processing units can be computing machines arranged in a cluster (e.g., such as in a data center or cloud computing infrastructure) where many hardware nodes work together and are managed via management and orchestration (MANO) function 15100, which, among other tasks, oversees monitoring and lifecycle management of various applications 1510. For example, MANO function 15100 can perform operations attributed to a monitoring function in the above descriptions of various embodiments. In some embodiments, computing platform 1500 can include a non-transitory storage medium 15200 that can be used to store and retrieve information used by MANO 15100. For example, non-transitory storage medium 15200 can include a database used to log AF entries and associated use case tags, such as described above in relation to various embodiments.

In some embodiments, processing units 1530 can be commercial off-the-shelf (COTS) units, such as graphics processing units (GPUs), rack-mounted x86 server boards (e.g., based on Intel or AMD processors), reduced instruction-set computer (RISC, e.g., ARM) boards, etc. Each processing unit 1530 can include processing circuitry 1560 and memory 1590. Memory 1590 can include non-persistent memory 1590-1 (e.g., for permanent or semi-permanent storage) and persistent memory 1590-2 (e.g., for temporary storage), each of which can store instructions 1595 (also referred to as software or computer program product).

Processing circuitry 1560 can include general-purpose or special-purpose hardware devices, such as one or more Intel x86-family processors (or equivalent), reduced instruction-set computing (RISC) processors (e.g., ARM), stream or vector multiprocessors, application-specific integrated circuits (ASICs), or any other type of processing circuitry including digital or analog hardware components. Each processing unit 1530 can include one or more high-speed communication interfaces 1570, each of which can include a physical network interface 1580. The respective communication interfaces 1570 can be used for communication among the processing units 1530, and/or with other computing hardware internal and/or external to system 1500.

Memory 1590 can store instructions 1595 executable by processing circuitry 1560 whereby various applications 1510 and services 1540 can be operative for various features, functions, procedures, etc. of the embodiments disclosed herein. Memory 1590 can also store instructions 1595 executable by processing circuitry 1560 to instantiate one or more virtualization layers 1550 (also referred to as hypervisor or virtual machine monitor, VMM). In some embodiments, virtualization layer 1550 can be used to provide a plurality of virtual machines (VMs) that are abstracted from the underlying processing units 1530. For example, virtualization layer 1550 can present a virtual operating platform that appears like computing hardware to services and/or applications hosted by environment 1500. Moreover, each VM (e.g., as facilitated by virtualization layer 1550) can manifest itself as a software implementation of a physical machine that runs programs as if they were executing on a physical, non-virtualized machine. Each VM can have dedicated processing units 1530 or can share resources of one or more processing units 1530 with other VMs.

In other embodiments, various services 1540 can be run on top of virtualization layer 1550. Each service provides some indivisible functionality that can be invoked and/or used by applications 1510. As such, services 1540 can also be referred to as atomic software functions (AFs). In some embodiments, services 1540 may be associated with a service API layer 1520 through which various applications 1510 access the respective services. As an example, service API layer 1520 can implement (at least in part) various logging functions described above in relation to various embodiments.

In some embodiments, some or all of processing units 1530 can include, or be implemented as trusted computing hardware. For example, these trusted processing units can have hardware features such as Intel SGX, AMD SEV, and/or ARM TrustZone. Likewise, some or all of services 1540 can be implemented as secure containers. In this manner, services 1540 running on trusted processing units 1530 can be trusted computing services (TCS).

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously.

1.-21. (canceled)

22. A method performed by a monitoring function for a computing environment configured to host a plurality of atomic software functions (AFs) that are usable by applications executing in the computing environment, the method comprising:
performing pattern analysis, on entries of a database operably coupled to the monitoring function, to identify one or more candidate recurrent patterns, wherein:
each database entry includes the following: an AF identifier uniquely associated with one of the AFs, and a time at which the identified AF was invoked in the computing environment, and
each candidate recurrent pattern includes a plurality of instances of a same sequence of AF identifiers in a same chronological order;
validating a first one or more of the candidate recurrent patterns as one or more of the following: applications, and use cases associated with at least one application;
assigning respective use case tags to the validated first candidate recurrent patterns; and
updating the database such that each assigned use case tag is stored in association with the database entries that are associated with the corresponding validated candidate recurrent pattern.

23. The method of claim 22, wherein validating the first candidate recurrent patterns is based on a complete match between each first candidate recurrent pattern and a reference AF sequence associated with one of the following: a predefined use case, or a complete higher-level logical activity or operation.

24. The method of claim 22, wherein:
a plurality of first candidate recurrent patterns are validated and assigned respective first use case tags;
validating the first candidate recurrent patterns comprises identifying a higher-level use case based on the plurality of first candidate recurrent patterns; and
the method further comprises assigning to the plurality of first candidate recurrent patterns a second use case tag corresponding to the higher-level use case.

25. The method of claim 22, further comprising identifying a second one or more of the candidate recurrent patterns as partially valid, based on a partial match between each second candidate recurrent pattern and a reference AF sequence associated with one of the following: a predefined use case, or a complete higher-level logical activity or operation.

26. The method of claim 25, wherein each partial match is based on one or more of the following differences between a candidate recurrent pattern and a reference AF sequence:
each AF sequence in the candidate recurrent pattern is missing a same one or more entries in the reference AF sequence; and
each AF sequence in the candidate recurrent pattern includes a same one or more entries that are missing from the reference AF sequence.

27. The method of claim 22, further comprising identifying a third one more of the candidate recurrent patterns as one or more of the following: invalid, an error condition, misuse of the computing environment, an artifact of the pattern analysis, and multiple repetitions of a random sequence of AF identifiers.

28. The method of claim 27, wherein:
performing pattern analysis comprises discarding any of the identified candidate recurrent patterns that appear on a rejected list; and
the method further comprises updating the rejected list to include the third candidate recurrent patterns or identifiers thereof.

29. The method of claim 22, further comprising, for each validated first candidate recurrent pattern, assigning respective tag instance identifiers to respective instances of the sequence of AF identifiers comprising the first candidate recurrent pattern, wherein the database is further updated such that the respective tag instance identifiers are stored in association with the database entries that are associated with the corresponding validated candidate recurrent pattern.

30. The method of claim 22, further comprising performing one or more of the following using the database updated to include the use case tags: benchmarking, automated testing, tracing, troubleshooting, identification of standard usage patterns and deviations therefrom, and system auditing for resource needs.

31. The method of claim 22, further comprising logging entries in the database for each invocation of one of the AFs in the computing environment, wherein pattern analysis is performed on the logged database entries.

32. The method of claim 22, wherein each database entry is logged by one of the following: a logging function separate from the monitoring function, an application programming interface (API) of the AF identified in the database entry, or an API of the database.

33. The method of claim 22, wherein each database entry also includes one or more of the following associated with the identified AF: an operation description, and operational parameters used for invocation.

34. The method of claim 22, wherein each AF identifier is in a human-readable format and each use case tag is in a human-readable format.

35. The method of claim 22, wherein performing pattern analysis on entries of the database to identify one or more candidate recurrent patterns comprises filtering or disregarding any differences, among the plurality of instances included in an identified candidate recurrent pattern, in database entries that are chronologically intervening but not part of the sequence of AF identifiers in each instance.

36. The method of claim 22, wherein:
the computing environment is associated with a communication network that includes at least two of the following domains: radio access network (RAN), core network (CN), IP multimedia system (IMS), and operations support system (OSS); and
each of the plurality of AFs is hosted by one of the domains of the communication network.

37. A monitoring function for a computing environment configured to host a plurality of atomic software functions (AFs) that are usable by applications executing in the computing environment, the monitoring function comprising:
communication interface circuitry configured to communicate with a database; and
processing circuitry operably coupled to the communication interface circuitry, whereby the processing circuitry and communication circuitry are configured to:
perform pattern analysis on entries of the database to identify one or more candidate recurrent patterns, wherein:
each database entry includes the following: an AF identifier uniquely associated with one of the AFs, and a time at which the identified AF was invoked in the computing environment, and
each candidate recurrent pattern includes a plurality of instances of a same sequence of AF identifiers in a same chronological order;
validate a first one or more of the candidate recurrent patterns as one or more of the following: applications, and use cases associated with at least one application;
assign respective use case tags to the validated first candidate recurrent patterns; and
update the database such that each assigned use case tag is stored in association with the database entries that are associated with the corresponding validated candidate recurrent pattern.

38. The monitoring function of claim 37, wherein the processing circuitry is configured to validate the first candidate recurrent patterns based on a complete match between each first candidate recurrent pattern and a reference AF sequence associated with one of the following: a predefined use case, or a complete higher-level logical activity or operation.

39. The monitoring function of claim 37, wherein:
a plurality of first candidate recurrent patterns are validated and assigned respective first use case tags;
the processing circuitry is configured to validate the first candidate recurrent patterns by identifying a higher-level use case based on the plurality of first candidate recurrent patterns; and
the processing circuitry is further configured to assign to the plurality of first candidate recurrent patterns a second use case tag corresponding to the higher-level use case.

40. The monitoring function of claim 37, wherein:
the processing circuitry is further configured to identify a second one or more of the candidate recurrent patterns as partially valid, based on a partial match between each second candidate recurrent pattern and a reference AF sequence associated with a predefined use case or with a complete higher-level logical activity or operation; and
each partial match is based on one or more of the following differences between a candidate recurrent pattern and a reference AF sequence:
each AF sequence in the candidate recurrent pattern is missing a same one or more entries in the reference AF sequence, and
each AF sequence in the candidate recurrent pattern includes a same one or more entries that are missing from the reference AF sequence.

41. A non-transitory, computer-readable medium storing computer-executable instructions that, when executed by processing circuitry associated with a monitoring function for a computing environment configured to host a plurality of atomic software functions (AFs), configure the monitoring function to perform the method of claim 22.
